(19) United States
(12) Patent Application Publication
(10) Pub. No.: US 2013/0168045 A1
(43) Pub. Date: Jul. 4, 2013

(54) RAM AIR CHANNEL ARRANGEMENT AND AIRCRAFT AIR CONDITIONING SYSTEM

(71) Applicant: Martin SCHMID, Hamburg (DE)

(72) Inventor: Martin SCHMID, Hamburg (DE)

(73) Assignee: AIRBUS OPERATIONS GMBH, Hamburg (DE)

(21) Appl. No.: 13/538,310

(22) Filed: Jun. 29, 2012

Related U.S. Application Data
(60) Provisional application No. 61/502,382, filed on Jun. 29, 2011.

(30) Foreign Application Priority Data
Jun. 29, 2011 (DE) 10 2011 105 968.0

(51) Int. Cl. B64D 13/06

(52) U.S. Cl. CPC B64D 13/06
USPC 165/96

(57) ABSTRACT

A ram air channel arrangement includes a ram air channel adapted to be flown through with ram air, a heat exchanger disposed in the ram air channel and including a ram air inlet for feeding the ram air flowing through the ram air channel into the heat exchanger and a ram air outlet for removing the ram air from the heat exchanger, and at least one flow control device having a cross section widening in the direction of the ram air inlet and positioned in the ram air channel upstream of the ram air inlet such that it guides the ram air flowing through the ram air channel in the direction of the ram air inlet and/or and at least one flow to control device having a cross section widening in the direction of the ram air outlet and positioned in the ram air channel downstream.

### CROSS REFERENCE TO RELATED APPLICATIONS

This application claims the benefit of and priority to U.S. Patent Provisional Application No. 61/502,382, filed Jun. 29, 2011, and German Patent Application No. 10 2011 105 968.0 filed Jun. 29, 2011, the contents of each of which are hereby incorporated by reference in their entirety.

### TECHNICAL FIELD

The present invention relates to a ram air channel arrangement and to an aircraft air conditioning system equipped with such a ram air channel arrangement.

### BACKGROUND OF RELATED ART

Currently in commercial aircraft so-called air-assisted air conditioning systems are conventionally used to air condition the aircraft cabin. An aircraft air conditioning system is used to cool the aircraft cabin, which would otherwise become overheated as a result of heat loads, such as for example insolation, body heat of the passengers and waste heat from equipment on board the aircraft. The aircraft air conditioning system moreover feeds sufficient fresh air into the aircraft cabin to ensure that there is a prescribed minimum oxygen content in the aircraft cabin. Air-assisted aircraft air conditioning systems as a rule comprise an air conditioning unit, to which compressed process air is supplied from the engines of the aircraft or a separate compressor. Provided in the air conditioning unit is a ram air channel arrangement, which is described for example in DE 10 2004 038 860 A1 or DE 10 2006 060 765 B3 and comprises a ram air channel, through which ambient air flows, as well as a heat exchanger unit disposed in the ram air channel, so that the process air in the course of flowing through the heat exchanger unit may be cooled by heat transfer to the ambient air flowing through the ram air channel.

In a ram air flow, which is conveyed through a heat exchanger disposed in a ram air channel, pressure losses occur particularly in the region of a ram air inlet of the heat exchanger as a result of the heat exchanger causing a narrowing of the cross section, through which the ram air flow may flow. These pressure losses are attributable at least partially to the formation of turbulence in the ram air flow that is to be conveyed through the heat exchanger. High pressure losses occur frequently if, for example as a result of restricted installation space, it is impossible to design the ram air channel in a way that enables a flow straight towards the ram air inlet of the heat exchanger, i.e. substantially at right angles to the cross-sectional area of flow of the heat exchanger ram air inlet. This leads to a reduction of the ram-air volume rate of flow through the heat exchanger and hence to an undesirable reduction of the cooling capacity of the heat exchanger.

### SUMMARY

The underlying object of the invention is to indicate a ram air channel arrangement as well as an aircraft air conditioning system having a heat exchanger, which is disposed in a ram air channel and is capable of particularly efficient operation.

This object is achieved by a ram air channel arrangement having the features of claim 1 and by an aircraft air conditioning system having the features of claim 11.

A ram air channel arrangement according to the invention comprises a ram air channel, which may be a ram air channel integrated into an aircraft air conditioning system but may also be any other ram air channel provided on board an aircraft. The ram air channel during operation has ambient air flowing through it and may comprise an NACA (National Advisory Committee for Aeronautics) ram air channel inlet disposed in the region of the aircraft skin, a diffuser formed downstream of the ram-air channel inlet, as well as a ram air channel outlet. The cross sections of flow of the ram air channel inlet and/or the ram air channel outlet may be controlled during operation of the ram air channel by appropriate positioning of one or more ram air channel inlet flaps and/or one or more ram air channel outlet flaps. While the aircraft is operating on the ground, the ambient air is conventionally fed through the ram air channel by means of a suitable feed device. For example a fan of an air cycle machine (ACM) may be used to feed ambient air through the ram air channel while the aircraft is operating on the ground. While the aircraft is flying, on the other hand, ambient air as a rule already flows through the ram air channel because of the pressure conditions in the region of the ram air channel inlet and the ram air channel outlet.

Disposed in the ram air channel is a heat exchanger, which comprises a ram air inlet for feeding the ram air flowing through the ram air channel into the heat exchanger as well as a ram air outlet for removing the ram air from the heat exchanger. The heat exchanger may be a single heat exchanger or a heat exchanger unit comprising a plurality of individual heat exchangers. The heat exchanger is preferably used to cool a gaseous or liquid medium by transferring heat to the ambient air flowing through the ram air channel.

The ram air channel arrangement according to the invention further comprises at least one flow control device, which is positioned in the ram air channel upstream of the ram air inlet of the heat exchanger in such a way that it guides the ram air flowing through the ram air channel in the direction of the ram air inlet of the heat exchanger. Alternatively or in addition thereto at least one flow control device may be positioned in the ram air channel downstream of the ram air outlet of the heat exchanger in such a way that it guides the ram air flowing through the ram air outlet of the heat exchanger through the ram air channel downstream of the heat exchanger and has a cross section widening in the direction of the ram air outlet of the heat exchanger.

The terms “upstream” and “downstream” are used in the context of the present application with reference to the direction of flow of the ram air through the ram air channel during normal operation of the ram air channel. The flow control device may consequently be positioned in the ram air channel in such a way that an ambient air flow flowing through the ram air channel approaches the flow control device first before reaching the ram air inlet of the heat exchanger. Alternatively or in addition thereto the flow control device may be positioned in the ram air channel in such a way that an ambient air flow flowing through the ram air outlet of the heat exchanger passes the flow control device first before flowing through the ram air channel downstream of the heat exchanger.

If the flow control device is positioned in the ram air channel upstream of the ram air inlet of the heat exchanger, the flow control device has a cross section widening in the direction of the ram air inlet of the heat exchanger. The flow control device then has only a small approach flow area in the region of an end remote from the ram air inlet of the heat exchanger. As a result of the cross section of the flow control device widening in the direction of the ram air inlet of the heat exchanger, the ram air flow is conveyed along a lateral surface area of the flow control device and finally guided in the direction of the ram air inlet of the heat exchanger.

If, on the other hand, the flow control device is positioned in the ram air channel downstream of the ram air outlet of the heat exchanger, the flow control device has a cross section widening in the direction of the ram air outlet of the heat exchanger. The flow control device then has only a small surface area in the region of an end remote from the ram air outlet of the heat exchanger. As a result of the cross section of the flow control device narrowing in the direction of the ram air channel downstream of the ram air outlet of the heat exchanger, the ram air flow is similarly conveyed along a lateral surface area of the flow control device and finally guided into the ram air channel downstream of the ram air outlet of the heat exchanger.

By virtue of equipping the ram air channel arrangement according to the invention with a previously described flow control device, it is possible to minimize or prevent turbulence in the ram air flow flowing through the ram air channel in the region of the ram air inlet of the heat exchanger and/or in the region of the ram air outlet of the heat exchanger. This makes it possible to reduce the pressure losses in the ram air flow in the region of the ram air inlet of the heat exchanger and/or in the region of the ram air outlet of the heat exchanger. The ram air channel arrangement according to the invention therefore enables the feeding of a large ram air volumetric flow through the heat exchanger. This in turn enables efficient operation of the heat exchanger with a high cooling capacity. By virtue of the ram air channel arrangement according to the invention it is therefore possible, optionally at least in specific operating situations, to dispense with increasing the ram air volumetric flow through the ram air channel by appropriate positioning of the ram air channel inlet flap(s) and/or the ram air channel outlet flap(s). It is consequently possible to minimize the aerodynamic drag caused by the ram air flaps while the aircraft is flying and hence reduce the fuel consumption of the aircraft.

The flow control device is preferably positioned in the ram air channel in such a way that it completely releases the flow cross section of the ram air inlet of the heat exchanger and/or of the ram air outlet of the heat exchanger. Such an arrangement of the flow control device ensures that the flow control device does not decrease the available cross section of flow of the ram air inlet and/or the ram air outlet of the heat exchanger and hence cause additional pressure losses at the ram air inlet and/or at the ram air outlet of the heat exchanger.

Given a configuration of the ram air channel arrangement, in which the flow towards the ram air inlet of the heat exchanger is straight, i.e. substantially at right angles to the cross-sectional area of flow of the ram air inlet of the heat exchanger, the flow control device, which may be configured for example in the form of a streamlined body, is preferably positioned in the ram air channel in such a “straight” manner that a longitudinal axis of the flow control device is aligned substantially parallel to the direction of flow of the ram air flow through the ram air channel and the heat exchanger and that there is a direct, i.e. straight flow towards an end of the flow control device remote from the ram air inlet of the heat exchanger. The ram air flow is then, as described above, guided along the lateral surface area of the flow control device in the direction of the ram air inlet of the heat exchanger. Similarly, given a configuration of the ram air channel arrangement, in which the flow passes through the ram air outlet of the heat exchanger in a straight manner, i.e. substantially at right angles to the cross-sectional area of flow of the ram air outlet of the heat exchanger, the flow control device, which may be configured for example likewise in the form of a streamlined body, may preferably be positioned in the ram air channel in such a “straight” manner that a longitudinal axis of the flow control device is aligned substantially parallel to the direction of flow of the ram air flow through the ram air channel and the heat exchanger. The ram air flow is then, as described above, likewise guided along the lateral surface area of the flow control device through the ram air channel downstream of the heat exchanger.

Given a ram air channel arrangement that is so designed that an oblique flow towards the ram air inlet of the heat exchanger occurs, i.e. a ram air channel portion disposed upstream of the heat exchanger extends at an angle <180° to the ram air channel portion accommodating the heat exchanger and the ram air flow consequently meets the cross-sectional area of flow of the ram air inlet of the heat exchanger at an angle <90°, the flow control device may be positioned likewise “obliquely” in the ram air channel. Given a flow control device positioned “obliquely” in the ram air channel, the longitudinal axis of the flow control device extends for example substantially parallel to the direction of flow of the ram air flow through the ram air channel and hence at an angle >180° to the direction of flow of the ram air flow through the heat exchanger. Such an arrangement of the flow control device then likewise enables a direct flow towards an end of the flow control device remote from the ram air inlet of the heat exchanger. Similarly, given a ram air channel arrangement that is so designed that a ram air channel portion disposed downstream of the heat exchanger extends at an angle <180° to the ram air channel portion accommodating the heat exchanger and the ram air flow consequently flows at an angle <90° from the cross-sectional area of flow of the ram air outlet of the heat exchanger into the ram air channel downstream of the heat exchanger, the flow control device may be positioned likewise “obliquely” in the ram air channel downstream of the heat exchanger.

An “obliquely” aligned flow control device may however, viewed in the direction of flow of the ram air flow through the ram air channel and the heat exchanger, cover part of the available cross-sectional area of flow of the ram air inlet of the heat exchanger and/or the ram air outlet of the heat exchanger. For this reason, also in a ram air channel arrangement, in which the ram air flow flowing through the ram air channel flows obliquely towards the ram air inlet of the heat exchanger and/or in which the ram air flow flows off obliquely from the ram air outlet of the heat exchanger, an arrangement of the flow control device in the ram air channel may be meaningful, in which the longitudinal axis of the flow control device is aligned substantially parallel to the direction of the ram air flow through the heat exchanger, so that there is an oblique flow towards the end of the flow control device remote from the ram air inlet and/or the ram air outlet of the heat exchanger.

The flow control device may in principle be constructed separately from the heat exchanger and positioned upstream and/or downstream of the heat exchanger in the ram air channel. However, in a preferred embodiment of the ram air channel arrangement according to the invention the flow control device is connected to the heat exchanger. The flow control device may then be conveniently fitted jointly with the heat exchanger in the ram air channel of the ram air channel arrangement. A connection of the flow control device to the heat exchanger moreover enables easy positioning of the flow control device, thereby making it easy to retrofit existing ram air channel arrangements with a flow control device.

For example the flow control device may be connected by a permanent or a detachable connection to the heat exchanger. Depending on the design of the flow control device and the heat exchanger, joining processes, such as for example welding, may be used to connect the heat exchanger to the flow control device. As an alternative to this it is also conceivable to connect the flow control device by a screw connection or the like to the heat exchanger. The flow control device preferably has a smooth surface and may be made for example of metal, in particular light metal, such as for example aluminium or an aluminium alloy. The flow control device may moreover be configured integral with the heat exchanger. It is then possible to dispense with a connection of the flow control device to the heat exchanger by joining.

The heat exchanger of the ram air channel arrangement according to the invention is preferably configured in the form of a plate heat exchanger, in which the ram air inlet comprises a plurality of for example slot-shaped ram air inlet portions disposed substantially parallel to one another. Given such a configuration of the heat exchanger, there is preferably a respective flow control device associated with at least some of the ram air inlet portions of the heat exchanger, which is positioned in the ram air channel upstream of the ram air inlet portion associated with it in such a way that it guides the ram air flowing through the ram air channel in the direction of the ram air channel inlet portion associated with it and has a cross section widening in the direction of the ram air inlet portion associated with it. A plate heat exchanger is notable for combining a comparatively simple style of construction with a high cooling capacity. By virtue of the association of flow control devices with the individual ram air inlet portions of the heat exchanger it is guaranteed that a low-turbulence and hence low-pressure-loss flow of the ram air out of the ram air channel into the individual ram air inlet portions of the heat exchanger is possible. A flow control device is preferably associated with each ram air inlet portion of the heat exchanger.

The heat exchanger of the ram air channel arrangement according to the invention may further be configured in the form of a plate heat exchanger, in which the ram air outlet comprises a plurality of for example slot-shaped ram air outlet portions disposed substantially parallel to one another. Given such a configuration of the heat exchanger, there is preferably a respective flow control device associated with at least some of the ram air outlet portions of the heat exchanger, which is positioned in the ram air channel downstream of the ram air outlet portion associated with it in such a way that it guides the ram air flowing through the ram air channel outlet portion associated with it through the ram air channel downstream of the heat exchanger and has a cross section widening in the direction of the ram air outlet portion associated with it. By virtue of the association of flow control devices with the individual ram air outlet portions of the heat exchanger it is guaranteed that a low-turbulence and hence low-pressure-loss flow of the ram air out of the individual ram air outlet portions of the heat exchanger is possible. A flow control device is preferably associated with each ram air outlet portion of the heat exchanger.

At least one flow control device associated with a ram air inlet portion of the heat exchanger is preferably connected to a region of the heat exchanger that separates two ram air inlet portions from one another. Furthermore, at least one flow control device associated with a ram air outlet portion of the heat exchanger may be connected to a region of the heat exchanger that separates two ram air outlet portions from one another. Such a configuration enables an easy connection of the flow control device to the heat exchanger. Each region of the heat exchanger that separates two ram air inlet portions and/or two ram air outlet portions of the heat exchanger from one another is preferably connected to a flow control device, which is then associated with an adjacent ram air inlet portion and/or ram air outlet portion of the heat exchanger.

The region of the heat exchanger that is to be connected to the flow control device is preferably a region of the heat exchanger that delimits a flow field of the heat exchanger, through which a fluid to be cooled may flow. Given such a configuration of the heat exchanger, a wall of the flow field of the heat exchanger, through which fluid to be cooled may flow, is therefore utilized as a mounting surface for the flow control device.

Mutually connected surface portions of at least one flow control device associated with a ram air inlet channel portion and of a region of the heat exchanger that separates two ram air inlet portions of the heat exchanger from one another are preferably of a substantially congruent construction. In other words, the flow control device is preferably designed in such a way that it substantially completely overlaps the region of the heat exchanger that is connected to it and separates two ram air inlet portions of the heat exchanger from one another. The heat exchanger then no longer has surface areas, towards which the ram air flow flowing through the ram air channel flows directly, i.e. in a straight manner at an angle of 180° or obliquely at an angle <180° and which may cause the formation of turbulence and hence pressure losses in the ram air flow. Rather, the ram air flow is guided by the streamlined flow control devices with low turbulence in the direction of the ram air inlet portions of the heat exchanger. In a similar fashion, mutually connected surface portions of at least one flow control device associated with a ram air outlet channel portion and of a region of the heat exchanger that separates two ram air outlet portions of the heat exchanger from one another may be of a substantially congruent construction.

The flow control device may at least in sections have a cross section in the shape of a triangle, a segment of a circle or a segment of an ellipse. For example the flow control device may have a cross section in the shape of a semi-circle or a semi-ellipse. The flow control device then has an end remote from the ram air inlet of the heat exchanger that has a small approach flow area and may then guide the ram air flow along its lateral surface area with low turbulence in the direction of the ram air inlet of the heat exchanger.

An aircraft air conditioning system according to the invention comprises a previously described ram air channel arrangement. The ram air channel arrangement is preferably integrated into an air conditioning unit of the aircraft air conditioning system and is used to cool process air that is bled from the engines of the aircraft or compressed by a separate compressor.

### BRIEF DESCRIPTION OF THE DRAWINGS

There now follows a detailed description of preferred embodiments of the invention with reference to the accompanying diagrammatic drawings, which show:

FIG. 1 illustrates a first embodiment of a ram air channel arrangement comprising a heat exchanger disposed in a ram air channel;

FIG. 2 illustrates a second embodiment of a ram air channel arrangement comprising a heat exchanger disposed in a ram air channel;

FIG. 3 illustrates a third embodiment of a ram air channel arrangement comprising a heat exchanger disposed in a ram air channel;

FIG. 4 illustrates a fourth embodiment of a ram air channel arrangement comprising a heat exchanger disposed in a ram air channel;

FIG. 5 illustrates a fifth embodiment of a ram air channel arrangement comprising a heat exchanger disposed in a ram air channel;

FIGS. 6 and 7 illustrate detail views of a plate heat exchanger suitable for use in a ram air channel arrangement according to FIGS. 1 to 5;

FIG. 8 illustrates the effect of various flow control devices in a ram air channel arrangement with a straight flow towards the heat exchanger;

FIG. 9 illustrates the effect of various flow control devices in a ram air channel arrangement with an oblique flow towards the heat exchanger, and

FIG. 10 illustrates a heat exchanger that is provided with various flow control devices both in the region of a ram air inlet and in the region of a ram air outlet.

### DETAILED DESCRIPTION

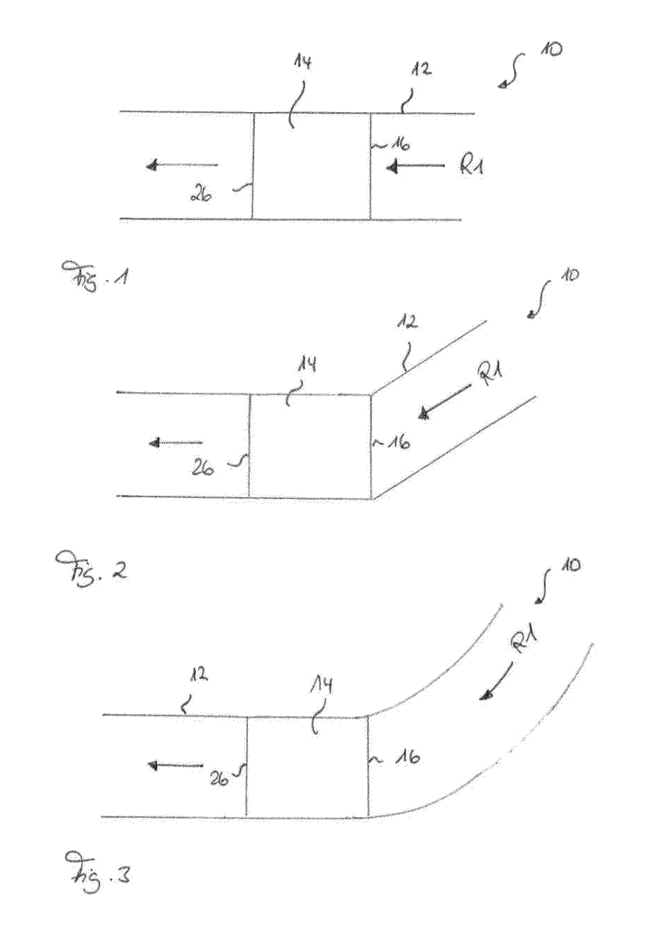

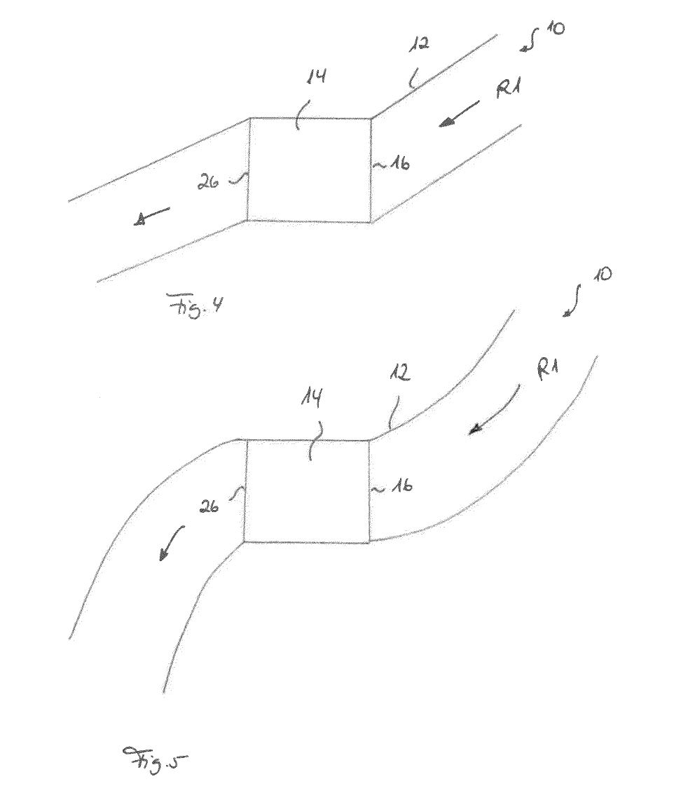

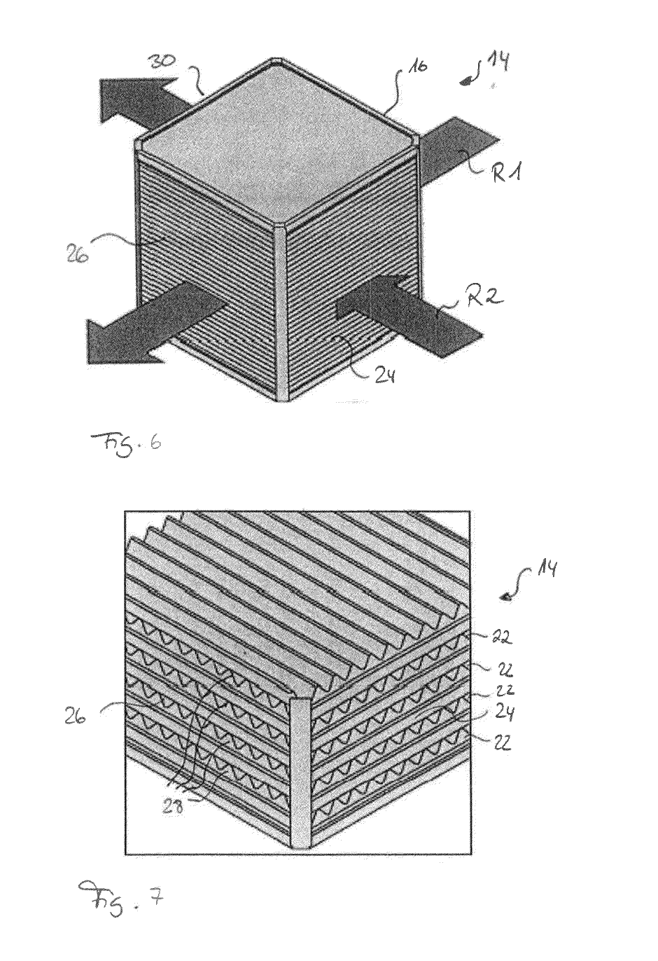

FIGS. 1 to 5 each show a ram air channel arrangement 10 having a ram air channel 12, through which ram air may flow in a direction R1. The ram air channel 12 has a ram air channel inlet, which is not represented in the figures, is disposed in the region of an aircraft skin and configured for example in the form of an NACA inlet, as well as a ram air channel is outlet that is formed likewise in the region of the aircraft skin. The ram air flow through the ram air channel 12 is controlled by appropriate positioning of one or more ram air channel inlet flaps and/or one or more ram air channel outlet flaps. While the aircraft is operating on the ground, the ambient air is conventionally fed through the ram air channel 12 by means of a suitable feed device, which is not shown in the figures. While the aircraft is flying, on the other hand, ambient air generally flows through the ram air channel 12 as a result of the pressure conditions in the region of the ram air channel inlet and the ram air channel outlet.

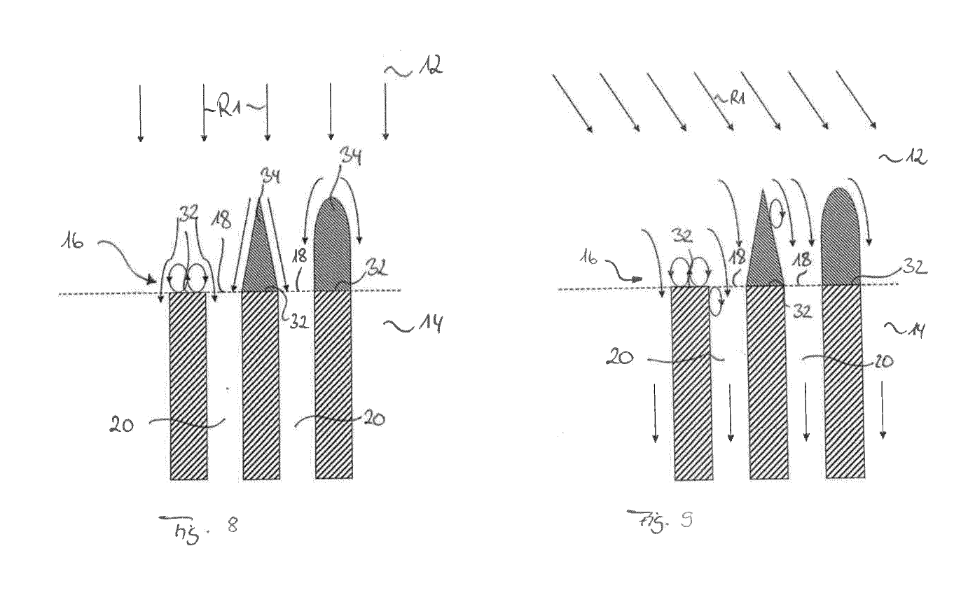

In the ram air channel 12 a heat exchanger 14 is disposed. As is evident from FIGS. 6 to 10, the heat exchanger 14 is configured in the form of a plate heat exchanger and has a ram air inlet 16 comprising a plurality of slot-shaped ram air inlet portions 18 disposed substantially parallel to one another. The ram air inlet portions 18 of the heat exchanger 14 open out into corresponding cooling channels 20, which may be seen in the cross-sectional representation according to FIGS. 8 to 10 and through which ram air may flow. The ram air, as it flows through the cooling channels 20, releases cooling energy to a fluid to be cooled, which is supplied to the heat exchanger 14 via a fluid inlet 24 that likewise comprises a plurality of slot-shaped fluid inlet portions 22 disposed substantially parallel to one another. The ram air and the fluid to be cooled flow crosswise through the heat exchanger 14, i.e. the fluid to be cooled is conveyed through the heat exchanger 14 in a direction R2 that is substantially at right angles to the direction of flow of the ram air through the heat exchanger 14.

After releasing its cooling energy to the fluid to be cooled, the ram air passes out of the heat exchanger 14 in the region of a ram air outlet 26 of the heat exchanger 14. Like the ram air inlet 16, the ram air outlet 26 of the heat exchanger 14 also comprises a plurality of slot-shaped ram air outlet portions 28 that are disposed substantially parallel to one another. The fluid to be cooled also leaves the heat exchanger 14 through a fluid outlet 30 comprising a plurality of slot-shaped fluid outlet portions that are disposed substantially parallel to one another.

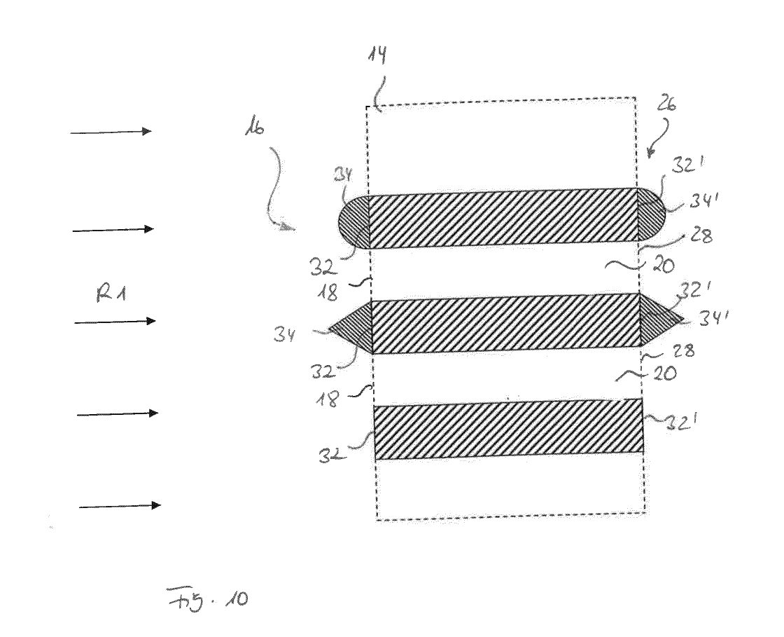

As may best be seen from the representation in FIGS. 8 to 10, the heat exchanger 14 comprises ram air inlet portions 18, through which ram air may flow and which are separated from one another by respective regions 32 of the heat exchanger 14. The heat exchanger regions 32 each delimit a flow field of the heat exchanger 14, through which the fluid to be cooled may flow. In a similar fashion, the ram air outlet portions 28 of the heat exchanger 14 are separated from one another by heat exchanger regions 32′ that likewise delimit flow fields of the heat exchanger 14, through which the fluid to be cooled may flow. Independently of whether the flow towards the heat exchanger ram air inlet 16 occurs in a straight manner, i.e. at an angle of ca. 180° to the direction R1 of the ram air flow through the ram air channel 12 (see FIGS. 8 and 10), or obliquely, i.e. at an angle <180° to the direction R1 of the ram air flow through the ram air channel 12 (see FIG. 9), turbulence develops at the surfaces, towards which the ram air stream flows, of the heat exchanger regions 32 separating adjacent ram air inlet portions 18 of the heat exchanger 14 from one another and leads to pressure losses in the ram air flow flowing through the ram air channel 12.

A minimizing of the pressure losses in the ram air flow in the region of the heat exchanger ram air inlet 16 may be achieved by means of flow control devices 34 that may be designed in various ways. In the embodiments of a ram air channel arrangement 10 that are shown in the figures, a flow control device 34 is associated with each ram air inlet portion 18 of the heat exchanger 14. Each flow control device 34 is positioned in the ram air channel 12 in such a way that it guides the ram air flowing through the ram air channel 12 in the direction of the ram air inlet 16 of the heat exchanger 14. Each flow control device 34 moreover has a cross section that widens in the direction of the ram air inlet 16 of the heat exchanger 14 and/or of the ram air inlet portion 18 associated with it. In other words, an end of the flow control device 34 that is remote from the ram air inlet 16 of the heat exchanger 14 and projects into the ram air flow flowing through the ram air channel 12 has a minimal approach flow area. The flow control devices 34 therefore guide the ram air flow along their lateral surface area in the direction of the ram air inlet portions 18. By means of the flow control devices 34 surface regions, where a direct approach flow occurs, are eliminated. It is therefore possible to reduce the generation of turbulence in the ram air flow in the region of the heat exchanger ram air inlet 16 and hence the pressure loss in the ram air flow.

In the arrangement according to FIG. 10 a flow control device 34′ is moreover also associated with each ram air outlet portion 28 of the heat exchanger 14. Each flow control device 34′ is positioned in the ram air channel 12 in such a way that it guides the ram air flowing through the ram air outlet 26 of the heat exchanger 14 into the ram air channel 12 downstream of the heat exchanger 14. Each flow control device 34′ has a cross section that widens in the direction of the ram air outlet 26 of the heat exchanger 14 and/or of the ram air outlet portion 28 associated with it. The flow control devices 34′ therefore guide the ram air flow along their lateral surface area in the direction of the ram air channel 12 downstream of the heat exchanger 14. It is therefore possible to reduce the generation of turbulence in the region of the heat exchanger ram air outlet 26 and hence the pressure loss in the ram air flow.

As shown in FIGS. 8 to 10, the flow control devices 34, 34′ may have a cross section in the shape of a triangle, a semi-circle or a semi-ellipse. Other streamlined configurations of the flow control devices 34, 34′ are equally conceivable. The flow control devices 34, 34′ are positioned in such a way that they fully release the cross section of flow of the heat exchanger ram air inlet 16, i.e. the available cross sections of flow of the ram air inlet portions 18 and/or the ram air outlet portions 28. The flow control devices 34, 34′ are connected for example by bonding to the heat exchanger 14 or are configured so as to be integrated with the heat exchanger 14. Surface portions of the flow control devices 34, 34′ that are connected to the heat exchanger 14 are configured to be congruent with the regions 32, 32′ of the heat exchanger 14 that separate two ram air inlet portions 18 and/or two ram air outlet portions 28 of the heat exchanger 14 from one another. The heat exchanger regions 32, 32′ are consequently overlapped completely by the flow control devices 34, 34′, with the result that surfaces with a direct approach flow, which are disadvantageous in terms of flow, are eliminated.

In the arrangements shown in FIGS. 8 to 10, both in the case of a straight flow towards the heat exchanger 14 (see FIGS. 8 and 10) and in the case of an oblique flow towards the heat exchanger 14 (see FIG. 9) a longitudinal axis of the flow control devices 34, 34′ extends substantially parallel to the direction R1 of the ram air flow through the ram air channel 12 and substantially likewise parallel to the cooling channels 20 that penetrate the heat exchanger 14. Given an oblique flow towards the heat exchanger 14, there is therefore also an oblique flow towards the flow control devices 34. Although turbulence does in fact arise in the ram air flow, it has less influence upon the pressure losses in the ram air flow than the turbulence that arises at free regions 32 of the heat exchanger 14. In principle it would be conceivable to align the flow control devices 34, i.e. the longitudinal axis thereof, in the case of an oblique flow towards the heat exchanger 14 parallel to the flow lines of the ram air flow through the ram air channel 12 upstream of the heat exchanger 14. However, in this case the flow control devices 34 would possibly overlap sub-regions of the ram air inlet portions 18.

1. Ram air channel arrangement comprising:
a ram air channel adapted to be flown through with ram air;
a heat exchanger disposed in the ram air channel and including a ram air inlet for feeding the ram air flowing through the ram air channel into the heat exchanger and a ram air outlet for removing the ram air from the heat exchanger; and
at least one first flow control device positioned in the ram air channel upstream of the ram air inlet of the heat exchanger in such a way that it guides the ram air flowing through the ram air channel in the direction of the ram air inlet of the heat exchanger and has a cross section widening in a direction of the ram air inlet of the heat exchanger.

2. The ram air channel arrangement according to claim 1, further comprising at least one second flow control device positioned in the ram air channel downstream of the ram air outlet of the heat exchanger in such a way that it guides the ram air flowing through the ram air outlet of the heat exchanger through the ram air channel downstream of the heat exchanger and has a cross section widening in a direction of the ram air outlet of the heat exchanger.

3. The ram air channel arrangement according to claim 2, wherein the at least one of the first and second flow control devices is positioned in the ram air channel in such a way that it completely releases the cross section of the heat exchanger.

4. The ram air channel arrangement according to claim 2, wherein the at least one of the first and second flow control devices is connected to the heat exchanger.

5. The ram air channel arrangement according to claim 2, wherein the at least one of the first and second flow control devices is connected to the heat exchanger by a permanent or detachable connection, by joining to the heat exchanger, or is configured integral with the heat exchanger.

6. The ram air channel arrangement according to claim 1, wherein the heat exchanger is configured in the form of a plate heat exchanger, in which the ram air inlet comprises a plurality of slot-shaped ram air inlet portions, and that a respective flow control device is associated with at least some of the ram air inlet portions positioned in the ram air channel upstream of the ram air inlet portion associated with it in such a way that it guides the ram air flowing through the ram air channel in a direction of the ram air inlet portion associated with it and has a cross section widening in the direction of the ram air inlet portion associated with it.

7. The ram air channel arrangement according to claim 2, wherein the heat exchanger is configured in the form of a plate heat exchanger, in which the ram air outlet comprises a plurality of slot-shaped ram air outlet portions, and that a respective flow control device is associated with at least some of the ram air outlet portions positioned in the ram air channel downstream of the ram air outlet portion associated with it in such a way that it guides the ram air flowing through the ram air outlet portion associated with it through the ram air channel downstream of the heat exchanger and has a cross section widening in the direction of the ram air outlet portion associated with it.

8. The ram air channel arrangement according to claim 2, wherein the at least one of the first and second flow control devices is connected to a region of the heat exchanger that separates two ram air inlet or outlet portions from one another.

9. The ram air channel arrangement according to claim 8, wherein the region of the heat exchanger separating two ram air inlet or outlet portions from one another delimits a flow field of the heat exchanger, adapted to be flown through with a fluid to be cooled.

10. The ram air channel arrangement according to claim 8, wherein mutually connected surface portions of at least one flow control device associated with a ram air inlet portion and of a region of the heat exchanger that separates two ram air inlet or outlet portions from one another are of a substantially congruent construction.

11. The ram air channel arrangement according to claim 2, wherein at least a portion of the at least one of the first and second flow control devices has a cross sectional shape selected from the group consisting of a triangle, a segment of a circle, and a segment of an ellipse.

12. Ram air channel arrangement comprising:
a ram air channel adapted to be flown through with ram air;
a heat exchanger disposed in the ram air channel and including a ram air inlet for feeding the ram air flowing through the ram air channel into the heat exchanger and a ram air outlet for removing the ram air from the heat exchanger; and
at least one first flow control device positioned in the ram air channel downstream of the ram air outlet of the heat exchanger in such a way that it guides the ram air flowing through the ram air outlet of the heat exchanger through the ram air channel downstream of the heat exchanger and has a cross section widening in a direction of the ram air outlet of the heat exchanger.

13. The ram air channel arrangement according to claim 12, further comprising at least one second flow control device positioned in the ram air channel upstream of the ram air inlet of the heat exchanger in such a way that it guides the ram air flowing through the ram air channel in the direction of the ram air inlet of the heat exchanger and has a cross section widening in a direction of the ram air inlet of the heat exchanger.

14. The ram air channel arrangement according to claim 13, wherein the at least one of the first and second flow control devices is positioned in the ram air channel in such a way that it completely releases the cross section of the heat exchanger.

15. The ram air channel arrangement according to claim 13, wherein the at least one of the first and second flow control devices is connected to the heat exchanger.

16. The ram air channel arrangement according to claim 13, wherein the heat exchanger is configured in the form of a plate heat exchanger, in which the ram air inlet comprises a plurality of slot-shaped ram air inlet portions, and that a respective flow control device is associated with at least some of the ram air inlet portions positioned in the ram air channel upstream of the ram air inlet portion associated with it in such a way that it guides the ram air flowing through the ram air channel in a direction of the ram air inlet portion associated with it and has a cross section widening in the direction of the ram air inlet portion associated with it.

17. The ram air channel arrangement according to claim 12, wherein the heat exchanger is configured in the form of a plate heat exchanger, in which the ram air outlet comprises a plurality of slot-shaped ram air outlet portions, and that a respective flow control device is associated with at least some of the ram air outlet portions positioned in the ram air channel downstream of the ram air outlet portion associated with it in such a way that it guides the ram air flowing through the ram air outlet portion associated with it through the ram air channel downstream of the heat exchanger and has a cross section widening in the direction of the ram air outlet portion associated with it.

18. The ram air channel arrangement according to claim 13, wherein the at least one of the first and second flow control devices is connected to a region of the heat exchanger that separates two ram air inlet or outlet portions from one another.

19. The ram air channel arrangement according to claim 18, wherein the region of the heat exchanger separating two ram air inlet or outlet portions from one another delimits a flow field of the heat exchanger, adapted to be flown through with a fluid to be cooled.

20. The ram air channel arrangement according to claim 18, wherein mutually connected surface portions of at least one flow control device associated with a ram air inlet portion and of a region of the heat exchanger that separates two ram air inlet or outlet portions from one another are of a substantially congruent construction.

21. The ram air channel arrangement according to claim 13, wherein at least a portion of the at least one first and second flow control devices has a cross sectional shape selected from the group consisting of a triangle, a segment of a circle, and a segment of an ellipse.

22. Aircraft air conditioning system, comprising a ram air channel arrangement according to claim 1.

23. Aircraft air conditioning system, comprising a ram air channel arrangement according to claim 12.
